(19) United States
(12) Patent Application Publication
(10) Pub. No.: US 2012/0319659 A1
(43) Pub. Date: Dec. 20, 2012

(54) SYSTEM AND METHOD FOR CONTROLLING CHARGE/DISCHARGE OF NON-AQUEOUS ELECTROLYTE SECONDARY BATTERY, AND BATTERY PACK

(76) Inventors: Masahiro Kinoshita, Osaka (JP); Kensuke Nakura, Osaka (JP); Takashi Hosokawa, Hyogo (JP)

(21) Appl. No.: 13/575,782

(22) PCT Filed: Aug. 25, 2011
(86) PCT No.: PCT/JP2011/004730

§ 371 Date: Jul. 27, 2012

(30) Foreign Application Priority Data
Oct. 4, 2010 (JP) 2010-225135
Oct. 29, 2010 (JP) 2010-224153

(51) Int. Cl. H02J 7/00

(52) U.S. Cl. 320/134

(57) ABSTRACT

A charge/discharge control system for controlling charge/discharge of a non-aqueous electrolyte secondary battery having a positive electrode including a composite oxide containing lithium and nickel. This system includes a charge/discharge circuit for discharging the secondary battery and charging the secondary battery with power from an external power source; and a control unit for controlling the charge/discharge circuit such that the voltage of the secondary battery is within a voltage range having a predetermined end-of-discharge voltage as a lower limit value and a predetermined end-of-charge voltage as an upper limit value. The control unit is configured to change at least the end-of-discharge voltage according to a variable related to deterioration of the secondary battery.

### TECHNICAL FIELD

This invention relates mainly to a method for controlling the charge/discharge of non-aqueous electrolyte secondary batteries, and particularly to a technique for extending the life of non-aqueous electrolyte secondary batteries.

### BACKGROUND ART

Non-aqueous electrolyte secondary batteries such as lithium ion secondary batteries can generate high voltage beyond the voltage for electrolysis of water, and also have high energy density. They are thus often used as the power source for notebook personal computers and other devices that continuously consume relatively large amounts of power. In particular, lithium ion secondary batteries have a small memory effect, and are suited for devices whose battery is often recharged from undischarged state, such as cellular phones and digital audio players.

However, not only non-aqueous electrolyte secondary batteries but also secondary batteries in general deteriorate due to repetition of charge/discharge. If a secondary battery has deteriorated, the amount of electricity generated from the secondary battery, during discharging from a certain voltage to another certain voltage, decreases. That is, deterioration of secondary batteries results in capacity loss.

To prevent capacity loss of secondary batteries due to deterioration, PTL 1 proposes charging a secondary battery in an early stage of use to a target capacity smaller than the total capacity.

PTL 2 proposes a charging method in which the frequency of overcharge is checked. If the frequency increases, it is assumed that the secondary battery has deteriorated, and the end-of-charge voltage is lowered. PTL 3 proposes lowering the end-of-charge voltage when the capacity becomes small. PTL 4 proposes lowering the end-of-charge voltage as the charge/discharge of a secondary battery is repeated. PTL 5 proposes lowering the end-of-charge voltage in a charge after a highly charged state continues.

As described above, in order to suppress deterioration of secondary batteries, proposals have been made to prevent secondary batteries from becoming fully charged. Also, proposals have been made to lower the end-of-charge voltage when secondary batteries have deteriorated.

### CITATION LIST

### Patent Literature

PTL 1: Japanese Laid-Open Patent Publication No. 2009-199774
PTL 2: Japanese Laid-Open Patent Publication No. 2007-325324
PTL 3: Japanese Laid-Open Patent Publication No. 2008-252960
PTL 4: Japanese Laid-Open Patent Publication No. 2008-5644
PTL 5: Japanese Laid-Open Patent Publication No. 2009-27801

### SUMMARY OF INVENTION

### Technical Problem

In non-aqueous electrolyte secondary batteries, the main cause of deterioration is believed to be repeated expansion and contraction of active materials due to charge/discharge. Among non-aqueous electrolyte secondary batteries, in the case of lithium ion secondary batteries, an active material is usually provided as a layer with a certain thickness attached to a surface of a current collector sheet (electrode substrate). When the active material repeatedly expands and contracts, the active material particles become cracked, and some of the particles are isolated. Since the isolated particles cannot conduct electrons to the current collector, they cannot contribute to the charge/discharge reactions of the electrode. As a result, the battery capacity decreases.

The cracking of the active material particles is mainly promoted by repeated charge/discharge to a state close to a fully discharged state (a state in which the variable x, described below, is close to the value 1). That is, when secondary batteries are charged and discharged at a relatively low SOC (state of charge) (hereinafter “low voltage range”), the cracking of the active material particles is promoted. Since the cracking of the active material particles and the deterioration of the electrolyte are causes of substantive deterioration in secondary batteries, they cause the battery capacity to decrease unlimitedly.

In contrast, when secondary batteries are charged and discharged at a relatively high SOC (hereinafter “high voltage range”), the substantive deterioration in the secondary batteries such as the cracking of the active material particles can be suppressed. Therefore, in order to extend the life of secondary batteries, it is preferable to operate the secondary batteries in a high voltage range.

However, if secondary batteries are charged and discharged in a high voltage range, the capacity loss of the secondary batteries increases rapidly due to polarization (polarization deterioration), although the capacity loss due to polarization stops when the amount of loss from the initial capacity reaches a certain ratio (e.g., 10%).

Since the capacity loss due to polarization is rapid, if a secondary battery is operated in a high voltage range, the usable time of the device powered by the secondary battery that is fully charged decreases sharply even in an early stage. For example, in the case of electric vehicles, the distance that can be driven decreases sharply in an early stage.

It is therefore an object of the invention to extend the life of secondary batteries and prevent a sharp capacity loss of secondary batteries due to polarization.

### Solution to Problem

This invention relates to a system for controlling charge/discharge of a non-aqueous electrolyte secondary battery. The system includes: a non-aqueous electrolyte secondary battery having a positive electrode including a composite oxide containing lithium and nickel; a charge/discharge circuit for discharging the secondary battery and charging the secondary battery with power from an external power source; and a control unit for controlling the charge/discharge circuit such that the voltage of the secondary battery is within a voltage range having an end-of-discharge voltage Y as a lower limit value and an end-of-charge voltage X as an upper limit value. The control unit is configured to change at least the end-of-discharge voltage Y according to a variable related to deterioration of the secondary battery.

In one aspect of the invention, the charge/discharge control system is characterized in that the control unit is configured to control the charge/discharge circuit such that: (i) when the degree D of deterioration of the secondary battery as the variable related to deterioration of the secondary battery is smaller than a reference value Dref, the secondary battery is charged and discharged in a voltage range A which is a low voltage range having a first end-of-charge voltage X1 as the end-of-charge voltage X and a first end-of-discharge voltage Y1 as the end-of-discharge voltage Y; and (ii) when the degree D of deterioration is equal to or more than the reference value Dref, the secondary battery is charged and discharged in a voltage range B which is a high voltage range having a second end-of-charge voltage X2 and a second end-of-discharge voltage Y2 higher than the first end-of-discharge voltage Y1.

The invention is also directed to a battery pack including: a non-aqueous electrolyte secondary battery having a positive electrode including a composite oxide containing lithium and nickel; a charge/discharge circuit for discharging the secondary battery and charging the secondary battery with power from an external power source; and a control unit for controlling the charge/discharge circuit for charging and discharging the secondary battery. The control unit is configured to control the charge/discharge circuit such that: (i) when the degree D of deterioration of the secondary battery is smaller than a reference value Dref, the secondary battery is charged and discharged in a voltage range A which is a low voltage range having a first end-of-charge voltage X1 and a first end-of-discharge voltage Y1; and (ii) when the degree D of deterioration is equal to or more than the reference value Dref, the secondary battery is charged and discharged in a voltage range B which is a high voltage range having a second end-of-charge voltage X2 and a second end-of-discharge voltage Y2 higher than the first end-of-discharge voltage Y1.

Further, the invention is directed to a method for controlling charge/discharge of a non-aqueous electrolyte secondary battery having a positive electrode including a composite oxide containing lithium and nickel. The method includes: (i) detecting the degree D of deterioration of the secondary battery; (ii) charging and discharging the secondary battery in a voltage range A which is a low voltage range having a first end-of-charge voltage X1 and a first end-of-discharge voltage Y1 when the degree D of deterioration is smaller than a reference value Dref; and (iii) charging and discharging the secondary battery in a voltage range B which is a high voltage range having a second end-of-charge voltage X2 and a second end-of-discharge voltage Y2 higher than the first end-of-discharge voltage Y1 when the degree D of deterioration is equal to or more than the reference value Dref.

In another aspect of the invention, the charge/discharge control system is characterized by including a voltage sensor for detecting the voltage of the secondary battery. The secondary battery has a rated capacity defined by a fully charged voltage Vfc and a fully discharged voltage Vfd. The control unit is configured to control the charge/discharge circuit based on an output of the voltage sensor such that: (i) the secondary battery is charged and discharged in a voltage range E having an end-of-charge voltage Vct1 as the end-of-charge voltage X and an end-of-discharge voltage Vdt1 as the end-of-discharge voltage Y where Vct1≦Vfc and Vdt1>Vfd; and (ii) the secondary battery is discharged to a voltage Vdt2 lower than the end-of-discharge voltage Vdt1 where Vdt2≧Vfd every time the number of charge/discharge cycles of the secondary battery as the variable related to deterioration of the secondary battery reaches a predetermined value.

The invention is also directed to a battery pack including: a non-aqueous electrolyte secondary battery having a positive electrode including a composite oxide containing lithium and nickel, the non-aqueous electrolyte secondary battery having a rated capacity defined by a fully charged voltage Vfc and a fully discharged voltage Vfd; a charge/discharge circuit for discharging the secondary battery and charging the secondary battery with power from an external power source; a control unit for controlling the charge/discharge circuit for charging and discharging the secondary battery; and a voltage sensor for detecting the voltage of the secondary battery. The control unit is configured to control the charge/discharge circuit based on an output of the voltage sensor such that: (i) the secondary battery is charged and discharged in a voltage range E which is a high voltage range having an end-of-charge voltage Vct1 and an end-of-discharge voltage Vdt1 where Vct1≦Vfc and Vdt1>Vfd; and (ii) the secondary battery is discharged to a voltage Vdt2 lower than the end-of-discharge voltage Vdt1 where Vdt2≧Vfd every time a predetermined number of charge/discharge cycles are performed.

Further, the invention is directed to a method for controlling charge/discharge of a non-aqueous electrolyte secondary battery having a positive electrode including a composite oxide containing lithium and nickel, the non-aqueous electrolyte secondary battery having a rated capacity defined by a fully charged voltage Vfc and a fully discharged voltage Vfd. The method includes: (i) charging and discharging the secondary battery in a voltage range E which is a high voltage range having an end-of-charge voltage Vct1 and an end-of-discharge voltage Vdt1 where Vct1≦Vct and Vdt1>Vfd; and (ii) discharging the secondary battery to a voltage Vdt2 lower than the end-of-discharge voltage Vdt1 where Vdt2≧Vfd every time a predetermined number of charge/discharge cycles are performed.

### Advantageous Effects of Invention

The invention can extend the life of a secondary battery without causing a sharp capacity loss of the secondary battery due to polarization in an early stage.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a functional block diagram of a charge/discharge system to which the method for controlling the charge/discharge of a secondary battery according to one embodiment of the invention is applied;

FIG. 2 is a graph showing exemplary characteristic curves of the capacity verses the number of charge/discharge cycles of a non-aqueous electrolyte secondary battery in a high voltage range and a low voltage range;

FIG. 3 is a table showing an example of table data on the relationship between variable x and battery voltage;

FIG. 4 is a flow chart of a voltage range switching process;

FIG. 5 is a graph showing an exemplary characteristic curve of the capacity verses the number of charge/discharge cycles when the method for controlling the charge/discharge of a secondary battery according to another embodiment of the invention is applied;

FIG. 6 is a flow chart of the method according to the above embodiment;

FIG. 7 is a flow chart of a capacity restoration process;

FIG. 8 is a flow chart of a zero SOC correction process; and

FIG. 9 is a graph showing the relationship between SOC and battery voltage.

### DESCRIPTION OF EMBODIMENTS

This invention relates to a system for controlling the charge/discharge of a non-aqueous electrolyte secondary battery having a positive electrode including a composite oxide containing lithium and nickel. This system includes a charge/discharge circuit for discharging the secondary battery and charging the secondary battery with power from an external power source; and a control unit for controlling the charge/discharge circuit such that the voltage of the secondary battery is within a voltage range having an end-of-discharge voltage Y as a lower limit value and an end-of-charge voltage X as an upper limit value. The control unit is configured to change at least the end-of-discharge voltage Y according to a variable related to deterioration of the secondary battery.

In one embodiment of the invention, the degree D of deterioration of the secondary battery is detected as the variable related to deterioration of the secondary battery. (i) When the degree D of deterioration is smaller than a reference value Dref, the secondary battery is charged and discharged in a voltage range A which is a low voltage range having a first end-of-charge voltage X1 as the end-of-charge voltage X and a first end-of-discharge voltage Y1 as the end-of-discharge voltage Y. (ii) When the degree D of deterioration is equal to or more than the reference value Dref, the secondary battery is charged and discharged in a voltage range B which is a high voltage range having a second end-of-charge voltage X2 and a second end-of-discharge voltage Y2 higher than the first end-of-discharge voltage Y1.

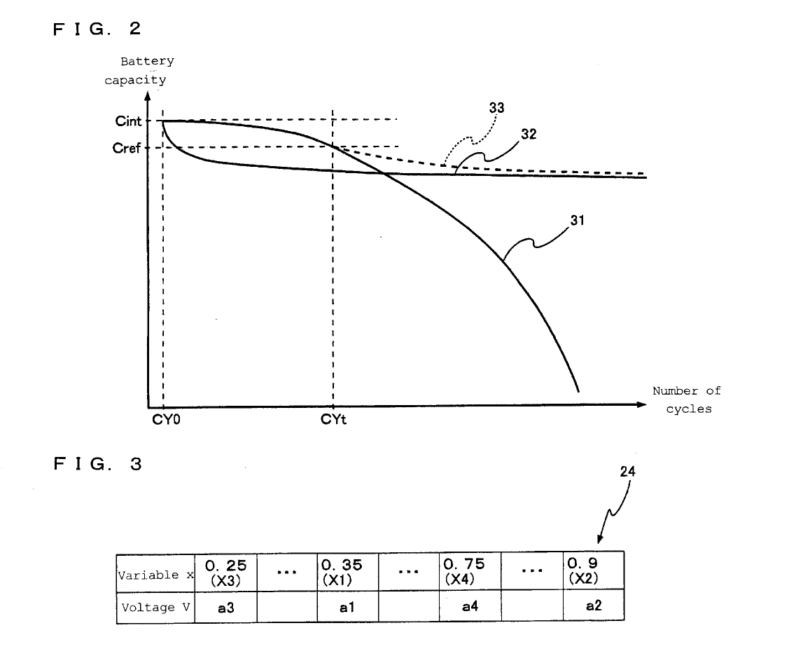

In the above embodiment, the voltage range for the charge/discharge of the secondary battery is switched based on the degree D of deterioration of the secondary battery. In an early stage in which the deterioration of the secondary battery is small (D<Dref), the secondary battery is charged and discharged in the voltage range A, which is a relatively low voltage range. This makes it possible to prevent a sharp capacity loss of the secondary battery due to polarization in an early stage (see the first half of the curve 31 in FIG. 2).

When the deterioration of the secondary battery increases to some extent (D≧Dref), the voltage range for the charge/discharge of the secondary battery is switched to the voltage range B, which is a relatively high voltage range. This makes it possible to suppress the substantive deterioration of the secondary battery due to cracking of the active material particles or the like (see the second half of the curve 32 in FIG. 2).

Accordingly, it is possible to extend the life of the secondary battery without causing a sharp capacity loss of the secondary battery in an early stage.

The second end-of-charge voltage X2, which is the upper limit value of the voltage range B, is preferably higher than the first end-of-charge voltage X1, which is the upper limit value of the voltage range A. This is consistent with the second end-of-discharge voltage Y2, which is the lower limit value of the voltage range B, being higher than the first end-of-discharge voltage Y1, which is the lower limit value of the voltage range A.

This makes it possible to reduce the difference between the maximum amount of electricity discharged from the charge/discharge of the secondary battery in the voltage range B and the maximum amount of electricity discharged from the charge/discharge of the secondary battery in the voltage range A. It is thus possible to prevent a large difference in maximum usable time of the device from occurring between before and after the switching of the voltage range.

In the above embodiment, the composite oxide is represented by the chemical formula LiₓNi_{y}M_{1-y}O₂₊ₐ where M is a metal element other than Li and Ni, 0<x≦1.1, 0<y≦1, and 0≦a≦0.1. The voltage range A corresponds to x1≦x≦x2, and the voltage range B corresponds to x3≦x≦x4, where x3<x1 and x4<x2.

In the chemical formula LiₓNi_{y}M_{1-y}O₂₊ₐ, x is a variable that changes according to the state of charge of the secondary battery. When the secondary battery is discharged, the variable x increases toward 1, and when the secondary battery is charged, the variable x decreases toward 0. That is, increase and decrease in variable x correlate with increase and decrease in the state of charge (SOC) of the secondary battery, and they increase and decrease oppositely.

According to the above configuration, in an early stage of deterioration in which the degree D of deterioration of the secondary battery is smaller than the reference value Dref, the secondary battery is charged and discharged such that x1≦x≦x2. Also, when the deterioration is severe to such an extent that the degree D of deterioration of the secondary battery is equal to or more than the reference value Dref, the secondary battery is charged and discharged such that x3≦x≦x4. The variable x is used to define the charge/discharge range of the secondary battery for the following reason.

For example, the crystal structure of composite oxides containing lithium and nickel represented by the chemical formula LiₓNi_{y}M_{1-y}O₂₊ₐ undergoes a phase transition when the variable x becomes specific values due to charge/discharge of the secondary battery. The transition of the crystal phase of the positive electrode material is closely related to cracking of the active material particles and polarization deterioration. Thus, by using the variable x to define the voltage range A and the voltage range B, it is possible to set the voltage range more appropriately to avoid a decrease in the life of the secondary battery due to the substantive deterioration and a sharp capacity loss due to polarization deterioration in an early stage. Therefore, the above configuration ensures the above-described advantageous effects of the invention.

Further, the use of composite oxides such as LiₓNi_{y}M_{1-y}O₂, in the invention makes it possible to reduce the use of expensive cobalt (Co) and decrease the costs of non-aqueous electrolyte secondary batteries.

In the charge/discharge system according to the above embodiment of the invention, x1, x2, x3, and x4 are, for example, such that 0.33≦x1≦0.37, 0.88≦x2≦0.92, 0.23≦x3≦0.27, and 0.73≦x4≦0.77.

By setting x1 and x2 in the above ranges, the voltage range A can be set appropriately so as not to cause a sharp capacity loss in an early stage. Also, by setting x3 and x4 in the above ranges, the voltage range B can be set appropriately so as not to promote the substantive deterioration of the secondary battery 16.

The degree D of deterioration of the secondary battery can be represented by various measures. For example, the degree D of deterioration can be represented by the number of charge/discharge cycles or the total discharge time. Also, the degree D of deterioration can be defined as the degree Dc of capacity decrease. When the degree D of deterioration is represented by the degree Dc of capacity decrease relative to the initial capacity Cint, the degree Dc of capacity decrease corresponding to the reference value Dref (hereinafter referred to as the reference value Dct of the degree of capacity decrease) is, for example, 5 to 20%.

The capacity C of the secondary battery can be obtained as the total amount of discharged electricity obtained when the secondary battery charged to the first end-of-charge voltage X1 is discharged to the first end-of-discharge voltage Y1. The degree Dc (%) of decrease of the capacity C of the secondary battery obtained in the above manner is 100×(1−(C/Cint)).

If the reference value Dct of the degree of capacity decrease is set to a value lower than 5%, the charge/discharge range of the secondary battery is switched early from the low voltage range to the high voltage range, and it may be difficult to prevent a sharp capacity loss of the secondary battery due to polarization deterioration. Such a problem can be easily prevented by setting the lower limit value of the reference value Dct of the degree of capacity decrease to 5%.

On the other hand, if the reference value Dct of the degree of capacity decrease is set to a value higher than 20%, the charge/discharge range of the secondary battery is switched late from the voltage range A to the voltage range B, and the substantive deterioration of the secondary battery may proceed, thereby resulting in a shortened life of the secondary battery. Such a problem can be easily prevented by setting the upper limit value of the reference value Dct of the degree of capacity decrease to 20%.

M can be at least one selected from the group consisting of Co, Mn, Al, Mg, Ti, Y, Zr, Nb, Mo, and W. Among them, inclusion of at least one of Co and Mn is preferable in order to obtain a high capacity. Further, when M_{1-y} is represented by Co_{z}L_{1-y-z}, L is preferably at least one selected from the group consisting of Mn, Al, Mg, Ti, Y, Zr, Nb, Mo, and W. In this case, preferably 0.5≦y≦0.9, for example, 0.7≦y≦0.9. Also, preferably 0.05≦z≦0.2. More preferably, L is Al in order to suppress the substantive deterioration more effectively.

Also, the invention can be embodied by a battery pack including: a non-aqueous electrolyte secondary battery having a positive electrode including a composite oxide containing lithium and nickel; a charge/discharge circuit for discharging the secondary battery to a load and charging the secondary battery with power from an external power source; and a control unit for controlling the charge/discharge circuit for charging and discharging the secondary battery. The control unit is configured to control the charge/discharge circuit such that: (i) when the degree D of deterioration of the secondary battery is smaller than a reference value Dref, the secondary battery is charged and discharged in a voltage range A having a first end-of-charge voltage X1 and a first end-of-discharge voltage Y1; and (ii) when the degree D of deterioration is equal to or more than the reference value Dref, the secondary battery is charged and discharged in a voltage range B having a second end-of-charge voltage X2 and a second end-of-discharge voltage Y2 higher than the first end-of-discharge voltage Y1.

Also, the invention can be embodied by a method for controlling charge/discharge of a non-aqueous electrolyte secondary battery having a positive electrode including a composite oxide containing lithium and nickel. This method includes: (i) detecting the degree D of deterioration of the secondary battery; (ii) charging and discharging the secondary battery in a voltage range A having a first end-of-charge voltage X1 and a first end-of-discharge voltage Y1 when the degree D of deterioration is smaller than a reference value Dref; and (iii) charging and discharging the secondary battery in a voltage range B having a second end-of-charge voltage X2 and a second end-of-discharge voltage Y2 higher than the first end-of-discharge voltage Y1 when the degree D of deterioration is equal to or more than the reference value Dref.

Another embodiment of the invention relates to a system, a method, and a battery pack for controlling charge/discharge of a non-aqueous electrolyte secondary battery having a rated capacity defined by a fully charged voltage Vfc and a fully discharged voltage Vfd. As used herein, the fully charged voltage Vfc refers to the terminal voltage of the secondary battery in a fully charged state. The fully discharged voltage Vfd as used herein refers to the terminal voltage of the secondary battery in a fully discharged state.

The charge/discharge control system in the above embodiment includes a charge/discharge circuit for discharging the secondary battery and charging the secondary battery with power from an external power source; a control unit for controlling the charge/discharge circuit for charging and discharging the secondary battery; and a voltage sensor for detecting the voltage of the secondary battery. The control unit is configured to control the charge/discharge circuit based on an output of the voltage sensor such that: (i) the secondary battery is charged and discharged in a voltage range E that is a relatively high voltage range having an end-of-charge voltage Vct1 and an end-of-discharge voltage Vdt1 where Vct1≦Vfc and Vdt1>Vfd; and (ii) the secondary battery is discharged to a voltage Vdt2 lower than the end-of-discharge voltage Vdt1 where Vdt2≧Vfd every time the number of charge/discharge cycles of the secondary battery as the variable related to deterioration of the secondary battery reaches a predetermined value.

In the above embodiment, in normal operation, the secondary battery is charged and discharged in the voltage range E having the end-of-charge voltage Vct1 and the end-of-discharge voltage Vdt1. This makes it possible to suppress the substantive deterioration of the secondary battery due to cracking of the active material particles or the like. It is thus possible to extend the life of the secondary battery.

However, when the secondary battery is repeatedly charged and discharged in the voltage range E, the capacity of the secondary battery may decrease sharply due to polarization deterioration. To avoid this, the secondary battery is discharged to the voltage Vdt2 lower than the end-of-discharge voltage Vdt1, which is the lower limit voltage of the voltage range E, every time a predetermined number of charge/discharge cycles are performed. As a result, every time the predetermined number of charge/discharge cycles are performed, the active material is temporarily activated to offset the capacity loss due to polarization deterioration, thereby making it possible to restore the capacity of the secondary battery close to the initial capacity (see the curve 33 in FIG. 5). It is thus possible to prevent a sharp capacity loss of the secondary battery due to polarization.

The above configuration can achieve the effects of extending the life of the secondary battery and preventing a sharp capacity loss of the secondary battery due to polarization. It should be noted that the voltage range E can be made equal to the voltage range B.

In the above embodiment, the composite oxide as the positive electrode material is represented by the chemical formula LiₓNi_{y}M_{1-y}O₂, where M is a metal element other than Li and Ni, 0<x≦1.1, 0<y≦1, and 0≦a≦0.1. The voltage range E corresponds to x5≦x≦x6 where 0.23≦x5≦0.27 and 0.73≦x6≦0.77. In the secondary battery in an early stage, the end-of-charge voltage Vct1 is 4.15 to 4.25 V (the values when graphite is used as the negative electrode material; hereinafter the same), and the end-of-discharge voltage Vdt1 is 3.55 to 3.65 V. Also, the rated capacity is, for example, 0.25≦x≦0.97. When the voltage range E and the voltage range B are equal, x1=x5 and x2=x6.

In non-aqueous electrolyte secondary batteries including composite oxides represented by the chemical formula LiₓNi_{y}M_{1-y}O₂₊ₐ as positive electrode materials, x in the composite oxides is a variable that changes according to the state of charge of the secondary battery. More specifically, when the secondary battery is discharged, the variable x increases toward 1, and when the secondary battery is charged, the variable x decreases toward 0. Therefore, the state of charge (SOC) of the secondary batteries can be defined by the variable x. Thus, the voltage range E can be defined as the range of the variable x: x5≦x≦x6. In this case, by setting that 0.23≦x1≦0.27 and 0.73≦x2≦0.77, the substantive deterioration of the secondary battery can be effectively suppressed. The reason for the use of the variable x to define the charge/discharge range of the secondary battery is as described above.

Further, by setting the values of x5 and x6 in the above ranges, it is possible to maximize the amount of electricity that can be generated from one cycle of charge/discharge of the secondary battery, while ensuring that the substantive deterioration of the positive electrode material comprising the composite oxide is prevented from being promoted.

It is preferable to set the above-mentioned predetermined number of charge/discharge cycles to 30 to 50. By setting the lower limit value of the predetermined number of charge/discharge cycles to 30, it is possible to decrease the frequency at which the secondary battery is discharged to the voltage Vdt2 lower than the desirable end-of-discharge voltage Vdt1. Thus, it is possible to effectively prevent the substantive deterioration of the secondary battery from being promoted. As a result, the life of the secondary battery can be extended. Further, for example, in the case of not being able to effectively utilize the power obtained by discharge to the voltage Vdt2, decreasing the frequency of discharge to the voltage Vdt2 allows energy loss to be reduced.

On the other hand, by setting the upper limit value of the predetermined number of charge/discharge cycles to 50, capacity loss can be restored at a suitable frequency, and capacity loss of the secondary battery due to polarization deterioration can be effectively suppressed. The more preferable range is 45 to 50. The method for counting the number of cycles is described below.

In another embodiment of the invention, the voltage Vdt2 corresponds to 0.93≦x7≦0.97 where x7 represents x of the composite oxide. By setting the voltage Vdt2 such that the variable x is in this range, it is possible to suppress the substantive deterioration of the secondary battery due to discharge to the relatively low voltage and effectively restore capacity loss due to polarization deterioration to prevent a sharp capacity loss of the secondary battery.

The voltage Vdt2 is 2.45 to 2.55 V when the secondary battery is in an early stage. The invention encompasses a case where the voltage Vdt2 is equal to the fully discharged voltage Vfd. However, in terms of suppressing the substantive deterioration of the secondary battery, it is preferable to set the voltage Vdt2 to a voltage that is as high as possible, while ensuring that capacity loss due to increased polarization voltage can be effectively restored. Therefore, the difference between Vdt1 and Vdt2, i.e., (Vdt1−Vdt2), is preferably in the range of 1.05 to 1.15 V.

In still another embodiment of the invention, in step (ii), while the secondary battery is discharged at a voltage higher than the end-of-discharge voltage Vdt1, the secondary battery is discharged at a discharge rate DRb of 0.5 to 2 C, and while the secondary battery is discharged at a voltage equal to or less than the end-of-discharge voltage Vdt1, the secondary battery is discharged at a discharge rate DRs of 0.1 to 0.5 C where DRs<DRb.

When the secondary battery is discharged to the voltage Vdt2 lower than the desirable end-of-discharge voltage Vdt1, if the discharge rate is too large, the substantive deterioration of the secondary battery may be promoted. Thus, at voltages equal to or lower than the end-of-discharge voltage Vdt1, the discharge rate is set in the range of 0.1 to 0.5 C. By setting the discharge rate to a low rate equal to or less than 0.5 C, the substantive deterioration of the secondary battery can be suppressed more effectively. On the other hand, by setting the lower limit value of the discharge rate to 0.1 C, it is possible to prevent the discharge time required for the voltage of the secondary battery to reach the voltage Vdt2 from becoming too long. This speeds up the process. The more preferable range is 0.15 to 0.3 C.

Further, in the process of discharging the secondary battery to the voltage Vdt2, while the secondary battery is discharged at a voltage higher than the end-of-discharge voltage Vdt1, the secondary battery is discharged at a high discharge rate of 0.5 to 2 C. This can shorten the time required for the process. The more preferable range is 0.7 to 1.2 C. 1 C is the value of current at which the amount of electricity corresponding to the rated capacity is discharged in 1 hour.

The above embodiment of the invention can further include a fully discharged state detector for detecting that the secondary battery is fully discharged. When the secondary battery is discharged to the voltage Vdt2, the secondary battery is further discharged until a fully discharged state is detected, to correct the association between x of the composite oxide in the fully discharged state and the fully discharged voltage Vfd.

The state of charge (SOC) of the secondary battery can be estimated from the voltage (e.g., the open circuit voltage (OCV)) of the secondary battery. That is, SOC can be calculated as the value α(V−Vfd′) obtained by multiplying the difference between the predetermined open circuit voltage Vfd′ of the secondary battery in a fully discharged state (0% SOC) (Vfd′ is the open circuit voltage corresponding to the fully discharged voltage Vfd) and the measured voltage V of the secondary battery by a predetermined coefficient α.

However, the voltage Vfd′ of the secondary battery corresponding to a fully discharged state actually changes due to deterioration of the secondary battery. Thus, deterioration of the secondary battery results in a difference between the actual SOC of the secondary battery and the SOC calculated based on the predetermined voltage Vfd′.

As such, in this system, when the secondary battery is discharged to the voltage Vdt2 to restore capacity loss due to polarization deterioration, the secondary battery is further discharged until a fully discharged state is detected, and the open circuit voltage of the secondary battery measured in the fully discharged state is replaced with the predetermined voltage Vfd′ to correct the association between x of the composite oxide and the fully discharged voltage Vfd. That is, zero SOC is corrected. This makes it possible to reduce the error in estimating the SOC or variable x based on the voltage of the secondary battery, and charge and discharge the secondary battery in a desired charge/discharge range more accurately.

The correction of zero SOC can be made every time the secondary battery is discharged to the voltage Vdt2, or can be made only once in a few times. For example, it is preferable to make the zero correction when the secondary battery is discharged to the voltage Vdt2 for the first time after the number Nfd of charge/discharge cycles performed from the previous zero correction reaches Nrf2 (Nrf2 is a natural number of 50 to 100).

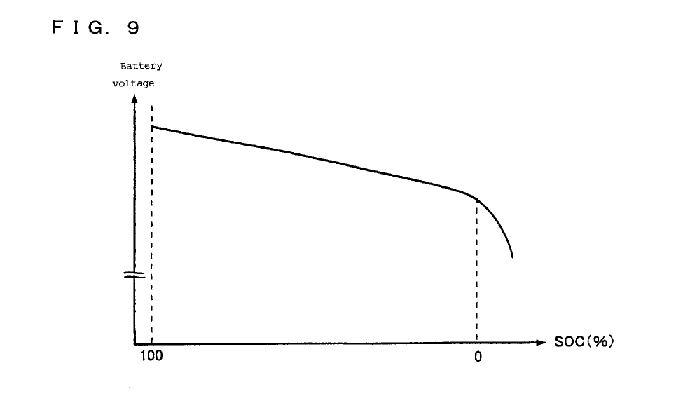

An example of the method for detecting that the secondary battery is fully discharged is a method of detection based on the rate of change of the voltage of the secondary battery discharged at a certain discharge rate. When the secondary battery is discharged at a certain discharge rate, the voltage drops sharply in the vicinity of a fully discharged state (see FIG. 9). Thus, for example, when the rate of voltage decrease (decrease is defined as positive) upon a discharge at a predetermined discharge rate reaches a predetermined value, it is determined that the secondary battery is fully discharged. The open circuit voltage of the secondary battery at that time is set as the new voltage Vfd′. In this manner, the association between x of the composite oxide in a fully discharged state and the fully discharged voltage Vfd can be corrected.

M can be at least one selected from the group consisting of Co, Mn, Al, Mg, Ti, Y, Zr, Nb, Mo, and W. Among them, inclusion of at least one of Co and Mn is preferable in order to obtain a high capacity. Further, when M_{1-y} is represented by Co_{z}L_{1-y-z}, L is preferably at least one selected from the group consisting of Mn, Al, Mg, Ti, Y, Zr, Nb, Mo, and W. In this case, preferably 0.5≦y≦0.9, for example, 0.7≦y≦0.9. Also, preferably 0.05≦z≦0.2. More preferably, L is Al in order to suppress the substantive deterioration more effectively.

The use of such composite oxides in the invention makes it possible to reduce the use of expensive cobalt (Co) and decrease the costs of non-aqueous electrolyte secondary batteries.

A battery pack in another embodiment of the invention includes: a non-aqueous electrolyte secondary battery having a positive electrode including a composite oxide containing lithium and nickel, the non-aqueous electrolyte secondary battery having a rated capacity defined by a fully charged voltage Vfc and a fully discharged voltage Vfd; a charge/discharge circuit for discharging the secondary battery and charging the secondary battery with power from an external power source; a control unit for controlling the charge/discharge circuit for charging and discharging the secondary battery; and a voltage sensor for detecting the voltage of the secondary battery. The control unit is configured to control the charge/discharge circuit based on an output of the voltage sensor such that: (i) the secondary battery is charged and discharged in a voltage range E having an end-of-charge voltage Vct1 and an end-of-discharge voltage Vdt1 where Vct1≦Vfc and Vdt1>Vfd; and (ii) the secondary battery is discharged to a voltage Vdt2 lower than the end-of-discharge voltage Vdt1 where Vdt2≧Vfd every time a predetermined number of charge/discharge cycles are performed.

A method for controlling charge/discharge of a non-aqueous electrolyte secondary battery in another embodiment of the invention relates to a method for controlling charge/discharge of a non-aqueous electrolyte secondary battery having a positive electrode including a composite oxide containing lithium and nickel, the non-aqueous electrolyte secondary battery having a rated capacity defined by a fully charged voltage Vfc and a fully discharged voltage Vfd. This method includes: (i) charging and discharging the secondary battery in a voltage range A having an end-of-charge voltage Vct1 and an end-of-discharge voltage Vdt1 where Vct1≦Vct and Vdt1>Vfd; and (ii) discharging the secondary battery to a voltage Vdt2 lower than the end-of-discharge voltage Vdt1 where Vdt2≧Vfd every time a predetermined number of charge/discharge cycles are performed.

Embodiments of the invention are hereinafter described with reference to drawings.

### Embodiment 1

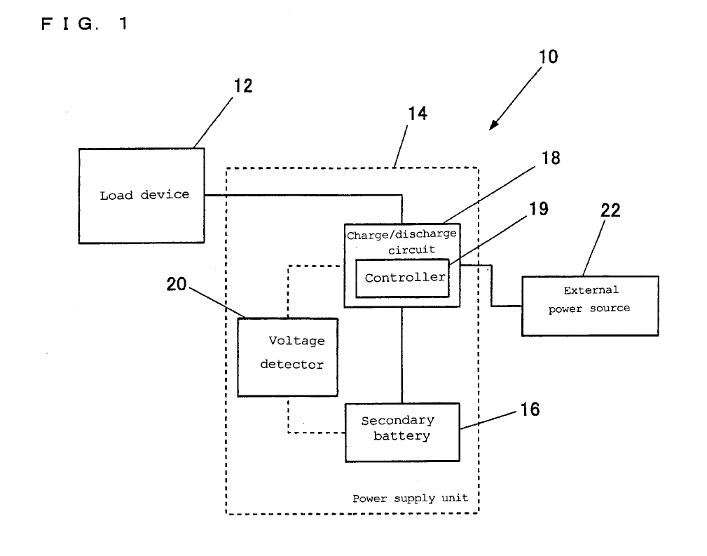

FIG. 1 is a functional block diagram showing an example of a charge/discharge system to which the method for controlling the charge/discharge of a secondary battery according to Embodiment 1 of the invention is applied.

A system 10 includes a load device 12 and a power supply unit 14 for supplying power to the load device 12. The power supply unit 14 includes a non-aqueous electrolyte secondary battery 16 such as a lithium ion secondary battery, a charge/discharge circuit 18 having a controller for controlling the charge/discharge of the secondary battery 16, and a voltage detector 20 for detecting the voltage of the secondary battery 16. The charge/discharge circuit 18 includes a controller 19 as the above-mentioned charge/discharge controller. The secondary battery 16 may be a single battery, or may comprise a plurality of batteries connected in parallel and/or in series. That is, the power supply unit 14 of the illustrated example is a so-called battery pack.

The controller 19 may be provided independently of the charge/discharge circuit 18. Alternatively, the controller 19 may be provided in the load device 12. Alternatively, it is also possible to provide a charger including the charging circuit and the controller 19 of the charge/discharge circuit 18 independently of the power supply unit 14, and connect the power supply unit 14 to the charger connected to an external power source 22 in order to charge the secondary battery 16.

The secondary battery 16 is connected to the load device 12 via the charge/discharge circuit 18, and can be connected to the external power source 22 such as a commercial power source via the charge/discharge circuit 18. The voltage detector 20 detects the voltage V (open circuit voltage (OCV)) and the closed circuit voltage (CCV) of the secondary battery 16, and sends the detected values to the controller 19.

The controller 19 controls the charge/discharge of the secondary battery 16 according to the voltage range switching process described below. Such a controller can be composed of a CPU (Central Processing Unit), a micro computer, an MPU (Micro Processing Unit: microprocessor), a main storage device, an auxiliary storage device, etc.

The auxiliary storage device (e.g., non-volatile memory) stores various data such as data on the degree D of deterioration of the secondary battery 16 and the reference value Dref, table data or relational formulae showing the relationship between the variable x and the voltage V, and the upper and lower limit values (x1, x2, x3, and x4) of the voltage range A (low voltage range) and the voltage range B (high voltage range).

The voltage range switching process is hereinafter described.

FIG. 2 shows characteristic curves of the capacity of a lithium ion secondary battery verses the number of charge/discharge cycles. In FIG. 2, the abscissa represents the number of cycles, while the ordinate represents the battery capacity (the total amount of electricity discharged in 1 cycle; hereinafter simply the “capacity”).

A curve 31 in the figure shows the characteristic of the capacity verses the number of charge/discharge cycles of a non-aqueous electrolyte secondary battery including a positive electrode containing a positive electrode active material represented by the chemical formula LiNi_{0.8}Co_{0.15}Al_{0.05}O₂ and a negative electrode including graphite as a negative electrode active material when the battery is charged and discharged in the range Rlow 0.35≦x≦0.9. In this case, one cycle includes the steps of: discharging the secondary battery 16 at 1 C from the upper limit state of charge (x=0.35) to the lower limit state of charge (x=0.9) in the range Rlow; allowing it to stand for 30 minutes; and recharging it to the upper limit state of charge in the range Rlow at a constant current and a constant voltage. The end-of-discharge voltage is 2.5 V.

1 C is the current at which the amount of electricity corresponding to the rated capacity is discharged in 1 hour. In the constant current charge, the secondary battery is charged at a charge current of 1 C until the terminal voltage of the secondary battery reaches an end-of-charge voltage (e.g., 3.9 V). In the constant voltage charge, it is charged at the end-of-charge voltage until the charge current lowers to an end of charge current (e.g., 0.05 C). The initial capacity obtained is represented by Cint.

When the secondary battery 16 is charged and discharged in the range Rlow, the SOC of the secondary battery 16 is low, and discharged to a state close to a fully discharged state (x=1). Thus, the range Rlow can be regarded as the voltage range A, which is a low voltage range.

As can be understood from the curve 31, when the secondary battery is charged and discharged in the voltage range A, the capacity decreases slowly, at first, due to an increase in cycle number, but after a certain number of cycles, the capacity decreases sharply. This is because the capacity decrease of the secondary battery charged and discharged in the voltage range A is mainly caused by the substantive deterioration in the secondary battery, such as cracking of the active material particles. Such the substantive deterioration of the secondary battery proceeds slowly in an early stage when the number of cycles is small, but when the number of cycles increases to a certain extent, the substantive deterioration accelerates.

That is, in the case of operating the secondary battery in the voltage range A, while the degree of deterioration of the secondary battery 16 is still small, the deterioration proceeds slowly. However, when the degree of deterioration becomes severe to some extent, the deterioration proceeds sharply.

A curve 32 shows the characteristic of the battery capacity verses the number of cycles of the secondary battery 16 charged and discharged in the range Rhgh 0.25≦x≦0.75. In this case, one cycle includes the steps of: discharging the battery at 1 C from the upper limit state of charge (x=0.25) to the lower limit state of charge (x=0.75) in the range Rhgh; allowing it to stand for 30 minutes; and recharging it to the upper limit state of charge in the range Rhgh at a constant current and a constant voltage. The end-of-discharge voltage is 3.55 V. The charge current of the constant current charge is, for example, 1 C. The end-of-charge voltage is, for example, 4.2 V. The end of charge current is, for example, 0.05 C. The initial capacity obtained is also represented by Cint.

When the secondary battery 16 is charged and discharged in the range Rhgh, the secondary battery 16 is charged and discharged at a relatively high SOC. Thus, the range Rhgh can be regarded as the voltage range B, which is a high voltage range.

As can be understood from the curve 32, when the secondary battery is repeatedly charged and discharged in the voltage range B, the battery capacity decreases sharply in an early stage. However, once the number of cycles increases to a certain extent, the battery capacity hardly decreases. This is because the capacity loss in the voltage range B is mainly caused by polarization deterioration. Polarization deterioration proceeds sharply in an early stage of the secondary battery 16.

Since polarization deterioration is not the substantive deterioration of the secondary battery 16, after the capacity decreases by a predetermined rate (e.g., 10% of the initial capacity), the capacity does not decrease any further. Therefore, by operating the secondary battery 16 in the voltage range B, the life of the secondary battery 16 can be extended.

It should be noted that even when the secondary battery 16 is charged and discharged in the voltage range A, polarization deterioration proceeds to some extent together with the substantive deterioration. However, in the case of charge/discharge in the voltage range A, the capacity loss due to polarization deterioration is offset because, for example, the change in the surface structure of the active material particles and the formation of coating due to decomposition of the electrolyte are suppressed. Therefore, in the charge/discharge in the voltage range A, a sharp capacity loss due to polarization deterioration does not occur.

The variable x correlates with the SOC of the secondary battery 16, and the SOC of the secondary battery 16 correlates with the voltage V. Therefore, by detecting the voltage V (e.g., open circuit voltage), the variable x at a given point of time can be determined.

FIG. 3 shows an example of table data on the relationship between the variable x and the voltage V. Table data 24 contains at least the lower limit value x1 and upper limit value x2 of the variable x in the voltage range A, the lower limit value x3 and upper limit value x4 of the variable x in the voltage range B, and the corresponding values of the voltage V. In the example shown therein, the table data 24 contains four variables x: 0.25 (x3), 0.35 (x1), 0.75 (x4), and 0.9 (x2); and the corresponding values of the voltage V: a1, a2, a3, and a4 (a3>a1>a4>a2).

The lower limit value x1 and upper limit value x2 of the variable x in the voltage range A and the lower limit value x3 and upper limit value x4 of the variable x in the voltage range B are not limited to those mentioned above. For example, when 0.33≦x1≦0.37 and 0.88≦x2≦0.92, the voltage range A is set to a suitable range which does not cause a sharp capacity loss in an early stage. For example, when 0.23≦x3≦0.27 and 0.73≦x4≦0.77, the voltage range B is set to a suitable range which does not promote the substantive deterioration of the secondary battery 16.

In the system 10, in an early stage when the degree D of deterioration of the secondary battery 16 is smaller than the reference value Dref, the secondary battery is operated in the voltage range A to prevent a sharp capacity loss due to polarization deterioration. On the other hand, when the degree D of deterioration of the secondary battery 16 is equal to or more than the reference value Dref, the secondary battery 16 is operated in the voltage range B to prevent the substantive deterioration.

The degree D of deterioration of the secondary battery 16 can be detected by various methods. Specific methods for determining that the degree D of deterioration is equal to or more than the reference value Dref are hereinafter described as examples.

### (Determination Method 1)

Deterioration of the secondary battery 16 increases as the number of charge/discharge cycles increases. Thus, when the number of charge/discharge cycles reaches a predetermined number or more, it can be determined that the degree D of deterioration is equal to or more than the reference value Dref. The number of charge/discharge cycles is counted as “one” only when an amount of electricity equal to or more than a predetermined amount is continuously charged, and such counting makes it possible to suppress the occurrence of an error.

It is preferable to set the number of charge/discharge cycles corresponding to the reference value Dref to 200 to 500, although it changes according to the specific battery structure (e.g., the composition, density, and thickness of the electrodes, and the kind of electrolyte). Also, the amount of continuously charged electricity necessary to count the number of cycles as “one” is roughly 10 to 20% of the rated capacity of the secondary battery.

If the number of charge/discharge cycles corresponding to the reference value Dref is set to a value lower than 200, the charge/discharge range of the secondary battery is switched early from the voltage range A to the voltage range B, and a sharp capacity loss of the secondary battery due to polarization deterioration may not be prevented. Such a problem can be easily prevented by setting the lower limit value of the number of charge/discharge cycles to 200. On the other hand, if the number of charge/discharge cycles corresponding to the reference value Dref is set to a value higher than 500, the charge/discharge range of the secondary battery is switched late from the voltage range A to the voltage range B, and the substantive deterioration of the secondary battery may proceed, thereby resulting in a shortened life of the secondary battery. Such a problem can be easily prevented by setting the upper limit value of the number of charge/discharge cycles to 500.

### (Determination Method 2)

The deterioration of the secondary battery 16 increases with an increase in time of use, i.e., the time of discharge for which the secondary battery 16 is discharged at a current equal to or more than a predetermined value. Therefore, when the time of discharge at a current equal to or more than a predetermined value has reached a predetermined time or more, it can be determined that the degree D of deterioration is equal to or more than the reference value Dref.

It is preferable to set the discharge time corresponding to the reference value Dref to a predetermined time of 1000 to 2500 hours, although it changes according to the specific battery structure (e.g., the composition, density, and thickness of the electrodes, and the kind of electrolyte). Also, the predetermined value of current used to count the discharge time is roughly 0.1 to 0.5 C.

If the discharge time corresponding to the reference value Dref is set to a value less than 1000 hours, the charge/discharge range of the secondary battery is switched early from the voltage range A to the voltage range B, and a sharp capacity loss of the secondary battery due to polarization deterioration may not be prevented. Such a problem can be easily prevented by setting the lower limit value of the discharge time to 1000 hours. On the other hand, if the discharge time corresponding to the reference value Dref is set to a value more than 2500 hours, the charge/discharge range of the secondary battery is switched late from the voltage range A to the voltage range B, and the substantive deterioration of the secondary battery may proceed, thereby resulting in a shortened life of the secondary battery. Such a problem can be easily prevented by setting the upper limit value of the discharge time to 2500 hours.

### (Determination Method 3)

The capacity of the secondary battery 16 decreases as the deterioration increases. Therefore, when the capacity of the secondary battery 16 has become equal to or less than a predetermined value, it can be determined that the degree D of deterioration is equal to or more than the reference value Dref.

In this embodiment in which the secondary battery 16 is charged and discharged first in the voltage range A, the capacity C can be determined by adding up the amounts of electricity generated by the secondary battery 16 when the secondary battery 16 is discharged from the upper limit state of charge in the voltage range A (e.g., the state in which x=0.35) to the lower limit state of charge (e.g., the state in which x=0.9). The capacity C is compared with the capacity (capacity reference value) Cref corresponding to the reference value Dct of the degree of capacity decrease. When the capacity C has become equal to or less than the capacity reference value Cref, it can be determined that the degree D of deterioration is equal to or more than the reference value Dref. The reference value Dct of the degree of capacity decrease is the reference value of the degree Dc of capacity decrease corresponding to the reference value Dref of the degree D of deterioration, as described above.

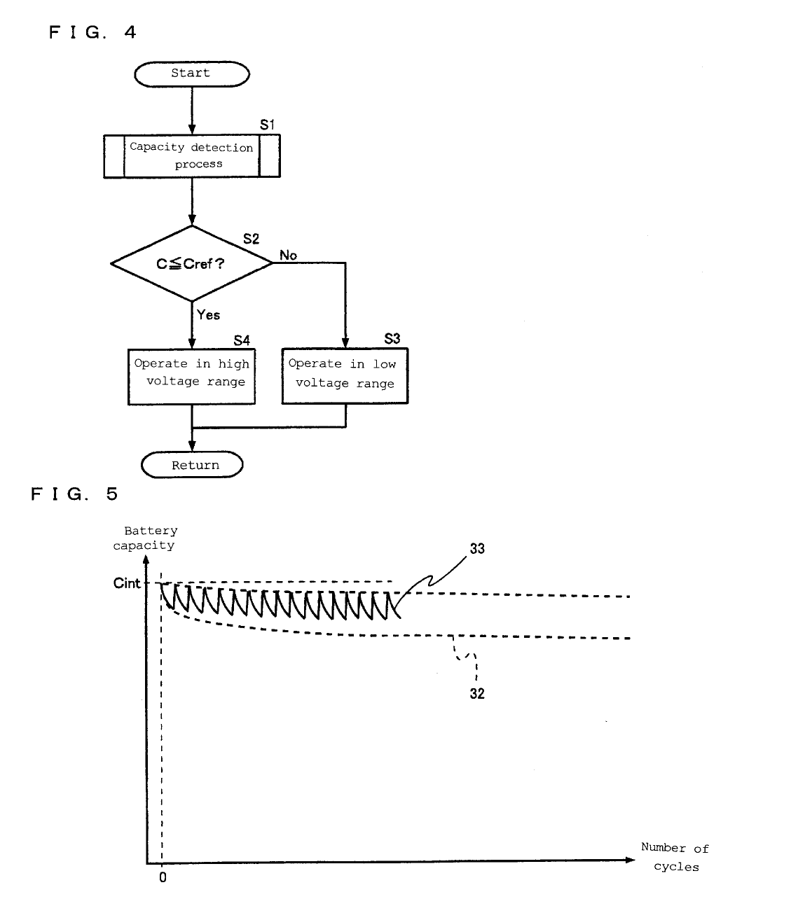

With reference to the flow chart of FIG. 4, the process for switching the voltage range according to the determination method 3 is described.

First, the capacity C of the secondary battery 16 is determined by the above method or the like (step S1). Then, whether the determined capacity C is equal to or less than the capacity reference value Cref is determined (step S2). If the capacity C is larger than the capacity reference value Cref (No in step S2), the charge/discharge range of the secondary battery is set to the voltage range A (e.g., the range Rlow), which is a low voltage range, in order to suppress a sharp capacity loss in an early stage due to polarization deterioration of the secondary battery 16 (step S3).

If the capacity C is equal to or less than the capacity reference value Cref (Yes in step S2), the charge/discharge range of the secondary battery is set to the voltage range B (e.g., the range Rhgh), which is a high voltage range, in order to suppress the substantive deterioration of the secondary battery 16 (step S4).

By the above process, the secondary battery 16 is operated in the voltage range A during the period in which the capacity C decreases from the initial capacity Cint to the capacity reference value Cref (the period from CY0 to CYt in FIG. 2). Therefore, in this period, the capacity of the secondary battery 16 changes as shown by the curve 31 representing the characteristic of battery capacity verses the number of cycles.

After the capacity C has decreased to the capacity reference value Cref, the charge/discharge range of the secondary battery 16 is switched to the voltage range B. Thus, the capacity of the secondary battery 16 then changes as shown by the curve 33 representing the characteristic of capacity verses the number of cycles, not the curve 31.

It is preferable to set the reference value Dct of the degree of capacity decrease to 5 to 20%. If the reference value Dct of the degree of capacity decrease is set to a value lower than 5%, the charge/discharge range of the secondary battery is switched too early from the voltage range A to the voltage range B, and a sharp capacity loss due to polarization deterioration may not be prevented. Such a problem can be easily prevented by setting the lower limit value of the reference value Dct of the degree of capacity decrease to 5%. On the other hand, if the reference value Dref is set to a value higher than 20%, switching from the voltage range A to the voltage range B is made too late, and the substantive deterioration of the secondary battery may proceed, thereby resulting in a shortened life of the secondary battery. Such a problem can be easily prevented by setting the upper limit value of the reference value Dct of the degree of capacity decrease to 20%.

As described above, the use of the degree Dc of capacity decrease as the degree D of deterioration of the secondary battery 16 makes it possible to accurately determine the timing of switching of proper charge/discharge range, thereby ensuring the advantageous effect of the invention, i.e., the effect of being able to extend the life of the secondary battery without causing a sharp capacity loss in an early stage.

Embodiment 2 of the invention is hereinafter described.

### Embodiment 2

The constituent components of the charge/discharge system to which the method for controlling the charge/discharge of a secondary battery according to Embodiment 2 is applied are the same as those of the charge/discharge system of FIG. 1, and the basic functions of the respective constituent components are also the same as those of the system of FIG. 1. Therefore, only the differences from the system of FIG. 1 are mainly described below. In the following description, the same reference characters as those of FIG. 1 are used.

In Embodiment 2, the controller 19 controls the charge/discharge of the secondary battery 16 basically in a predetermined voltage range. Such a controller can be composed of a CPU (Central Processing Unit), a micro computer, an MPU (Micro Processing Unit: microprocessor), a main storage device, an auxiliary storage device, etc. In this embodiment, the controller 19 forms a fully discharged state detector. However, there is no limitation thereto, and an additional CPU or the like may be used to form a fully discharged state detector.

The auxiliary storage device (e.g., non-volatile memory) stores various data such as table data or relational formulae showing the relationship between the variable x, SOC, and the voltage V, zero SOC (fully discharged voltage Vfd), the upper and lower limit values (x5 and x6) of the charge/discharge range, and discharge voltage (voltage Vdt2, and x7 which is the value x corresponding thereto) for performing a process of eliminating polarization deterioration.

The process performed by the controller 19 is described below. As described with reference to the characteristic curve of capacity verses the number of charge/discharge cycles in FIG. 2, capacity loss due to polarization deterioration occurs sharply. Thus, if the secondary battery 16 is operated in a high voltage range, the operating time of the load device 12 powered by the secondary battery is shortened sharply.

To avoid this, in the system 10, a process for restoring capacity loss due to polarization deterioration is performed regularly.

A saw-like curve 33 in FIG. 5 is a characteristic curve of battery capacity verses the number of charge/discharge cycles obtained by performing a capacity restoration process regularly.

Further, in the system 10, a process for correcting zero SOC of the secondary battery is also performed regularly by utilizing the capacity restoration process.

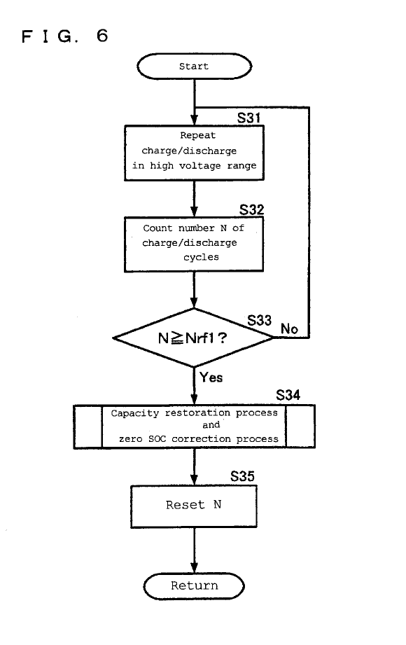

With reference to the flow chart of FIG. 6, the above processes are specifically described.

The controller 19 controls such that the secondary battery 16 is repeatedly charged and discharged in a voltage range E (e.g., the range corresponding to 0.25(x5)≦x≦0.75(x6)), which is a high voltage range (step S31). That is, when the secondary battery 16 is charged, for example, the voltage Vx1 corresponding to x=0.25 (x5) is set to the end-of-charge voltage Vct to charge the secondary battery 16. When the secondary battery 16 is discharged to supply power to the load device 12 or the like, for example, the voltage Vx2 corresponding to x=0.75 (x6) is set to the end-of-discharge voltage Vdt1 to discharge the secondary battery 16. The voltage range E can be set to the same voltage range as the voltage range B.

Also, the controller 19 counts the number N of charge/discharge cycles (step S32). The number N of charge/discharge cycles can be obtained by counting how many times the secondary battery 16 is charged. Only when an amount of electricity equal to or more than a predetermined amount (e.g., the amount of electricity equal to or more than 5% of the rated capacity) is continuously charged, the number of cycles is counted as “one”, and such counting makes it possible to suppress the occurrence of an error.

Next, whether the counted number N of charge/discharge cycles has reached a predetermined cycle number Nrf1 (e.g., 30≦Nrf1≦50) is determined (step S33). If N has not reached Nrf1 (No in step S33), steps S31 to S33 are repeated until N reaches Nrf1. If N has reached Nrf1 (Yes in step S33), the capacity restoration process is performed, and the process for correcting zero SOC is performed in the capacity restoration process (step S34). It is preferable to perform the capacity restoration process and the zero SOC correction process immediately before charging the secondary battery 16, or on that occasion, for example, on the occasion of connecting the secondary battery 16 to the charger 7 or the external power source 22.

Upon completion of the capacity restoration process and the zero SOC correction process, the counted number N of charge/discharge cycles is reset to “0” (step S35), to return to step S1.

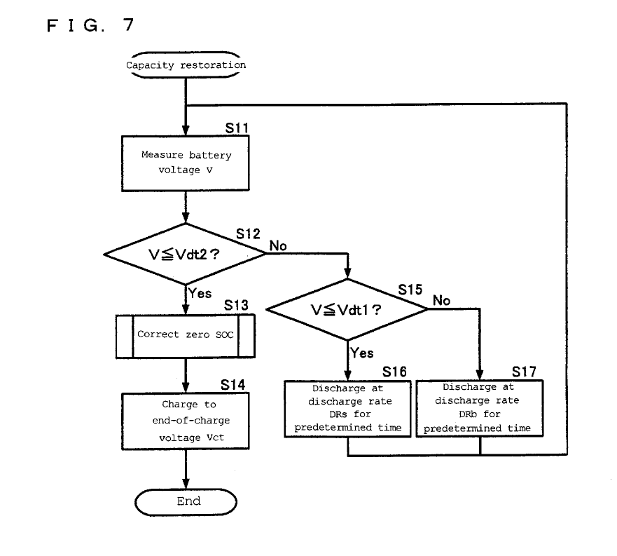

With reference to the flow chart of FIG. 7, the capacity restoration process is described. In the following description, the capacity restoration process is performed when the secondary battery 16 is charged.

First, the voltage V of the secondary battery 16 is measured (step S11). Then, whether the voltage V is equal to or less than the voltage Vdt2 for restoring capacity is determined (step S12).

If V is equal to or less than Vdt2 (Yes in step S12), it is assumed that the capacity has been restored due to discharge of the secondary battery 16 to a relatively low voltage, to proceed to the zero SOC correction process (step S13). Upon completion of the zero SOC correction process, the secondary battery 16 is charged to the end-of-charge voltage Vct (step S14), to complete the process.

On the other hand, if the voltage V is larger than the voltage Vdt2 in step S12, whether the voltage V is equal to or less than the end-of-discharge voltage Vdt1 is determined (step S15). If V is equal to or less than Vdt1 (Yes in step S15), the secondary battery 16 is discharged at a relatively small discharge rate DRs in the range of 0.1 to 0.5 C for a predetermined time (e.g., 1 second) (step S16), to return to step S11. As such, when the voltage V is in the range of Vdt2 to Vdt1, the secondary battery 16 is discharged at the relatively small discharge rate DRs. In consequence, even if the secondary battery 16 is discharged to a relatively low voltage, promotion of deterioration can be suppressed. Also, by setting the lower limit of the discharge rate DRs to 0.1 C, it is possible to prevent the process from requiring too much time.

On the other hand, if the voltage V is higher than the voltage Vdt1 (No in step S15), the secondary battery 16 is discharged at a relatively large discharge rate DRb of 0.5 to 2.0 C for a predetermined time (e.g., 1 second) (step S17), and then the process returns to step S11. Thus, until the voltage V drops to Vdt1, the secondary battery 16 is discharged at the relatively large discharge rate DRb. Hence, the process can be performed quickly. The reason why the upper limit of the discharge rate DRb is set to 2.0 C is to prevent the deterioration of the secondary battery 16 from being promoted by discharge of the secondary battery 16 at an excessive discharge rate.

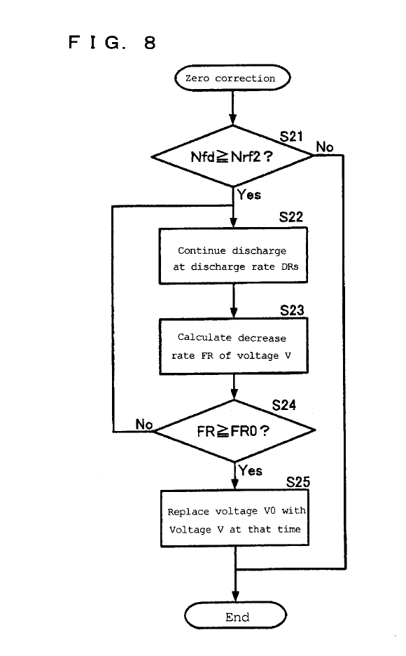

Referring now to the flow chart of FIG. 8, the zero SOC correction process in step S13 is described.

First, whether the number Nfd of charge/discharge cycles performed from the previous zero SOC correction process has reached a predetermined cycle number Nrf2 (50≦Nrf2≦100) is determined (step S21). If Nfd has not reached Nrf2 (No in step S21), it is determined not to perform the zero SOC correction process in this capacity restoration process, and the process is completed.

If Nfd has reached Nrf2 (Yes in step S21), the discharge at the discharge rate DRs is continued so as to fully discharge the secondary battery 16 (step S22). To determine whether or not the secondary battery 16 has been fully discharged, the decrease rate FR of the voltage V of the secondary battery 16 at the discharge rate DRs (decrease of the voltage V is defined as positive) is calculated (step S23). The decrease rate FR can be determined by measuring the voltage V of the secondary battery 16, for example, every 1 second, and based on the amount of change of the measured values.

Next, whether the calculated decrease rate FR is equal to or more than a predetermined value FR0 is determined (step S24). If FR is less than FR0 (No in step S24), it is assumed that the secondary battery 16 is not fully discharged, and the process returns to step S22 to continue the discharge of the secondary battery 16. If FR is equal to or more than FR0 (No in step S24), it is assumed that the secondary battery 16 is fully discharged at that time, and the voltage V at that time is replaced with the previous fully discharged voltage Vfd to correct zero SOC (step S25).

As described above, a determination that the secondary battery 16 is fully discharged is made based on the decrease rate FR of the voltage V, because as shown in FIG. 7, if the SOC lowers to near 0%, the voltage V drops sharply.

As described above, in this embodiment, by utilizing the occasion of discharging the secondary battery 16 to the voltage Vdt2 lower than the normal end-of-discharge voltage Vdt1 to eliminate polarization deterioration, the secondary battery 16 is discharged until a fully discharged state is detected to correct zero SOC, i.e., the association between the variable x and the battery voltage V. This makes it possible to minimize the electrical energy wasted when the secondary battery 16 is discharged to zero SOC.

Examples and Comparative Examples of the invention are hereinafter described. The invention is not to be construed as being limited to the following Examples.

### Example 1

A non-aqueous electrolyte secondary battery having a positive electrode including a positive electrode active material represented by the chemical formula LiNi_{0.8}Co_{0.15}Al_{0.05}O₂ and a negative electrode including graphite was prepared as a cylindrical sample battery (capacity: 1 Ah). The battery was repeatedly charged and discharged 1000 cycles in the range 0.25≦x≦0.75 (charge/discharge process). The discharge current was set to 1 C. The end-of-discharge voltage was set to 3.6 V. After the discharge, the secondary battery was left for 30 minutes. The charge current for a constant current charge was set to 1 C. The end-of-charge voltage was set to 4.2 V. The end-of-charge current for a constant voltage charge was set to 0.05 C. The secondary battery 16 was discharged to a voltage corresponding to x=0.95 every 50 cycles as a capacity restoration process.

### Example 2

A charge/discharge process and a capacity restoration process were performed under the same conditions as those of Example 1 except that the range of x of the charge/discharge was set to 0.3≦x≦0.75.

### Example 3)

A charge/discharge process and a capacity restoration process were performed under the same conditions as those of Example 1 except that the range of x of the charge/discharge was set to 0.25≦x≦0.9.

### Example 4

A charge/discharge process and a capacity restoration process were performed under the same conditions as those of Example 1 except that the range of x of the charge/discharge was set to 0.3≦x≦0.9.

### Comparative Example 1

A charge/discharge process was performed under the same conditions as those of Example 1. No capacity restoration process was performed.

### Comparative Example 2

A charge/discharge process was performed under the same conditions as those of Example 2. No capacity restoration process was performed.

### Comparative Example 3

A charge/discharge process was performed under the same conditions as those of Example 3. No capacity restoration process was performed.

### Comparative Example 4

A charge/discharge process was performed under the same conditions as those of Example 4. No capacity restoration process was performed.

The capacities of 10 batteries of each of Examples 1 to 4 and Comparative Examples 1 to 4 (the capacities in the voltage range of 2.5 to 4.2 V) were measured and averaged, and the results are shown in Table 1.

TABLE 1

| | Capacity (mAh) |
|---|---|
| Example 1 | 901 |
| Example 2 | 924 |
| Example 3 | 605 |
| Example 4 | 757 |
| Comparative Example 1 | 866 |
| Comparative Example 2 | 897 |
| Comparative Example 3 | 463 |
| Comparative Example 4 | 601 |

Examples 1 to 4, in which the capacity restoration process was performed, exhibited higher capacities than Comparative Examples 1 to 4, in which the charge/discharge range was the same but no capacity restoration process was performed. This result has confirmed that by performing the capacity restoration process every time a predetermined number of charge/discharge cycles are performed, capacity loss can be reduced.

Of Examples 1 to 4, Examples 1 and 2 have capacity retention rates of 90% or more, but Example 3 has a capacity retention rate of approximately 61% and Example 4 has a capacity retention rate of approximately 76%. This result can be ascribed to the fact that the upper limit of x of Examples 1 and 2 is 0.75, whereas the upper limit of x of Examples 3 and 4 is 0.9. By setting the upper limit of x to 0.75, the end-of-discharge voltage is set to a more suitable voltage, thereby resulting in high capacity retention rate.

A comparison between Example 1 and Example 2 shows that Example 2 has a slightly higher capacity retention rate. This is probably because the lower limit of x of Example 2 is 0.3, whereas the lower limit of x of Example 1 is 0.25. Since the voltage range of the charge/discharge is smaller in Example 2 than in Example 1, the battery deterioration in Example 2 was reduced slightly more than in Example 1. In this regard, the same result was obtained from Example 3 and Example 4.

It should be noted, however, that if the voltage range of the charge/discharge is narrowed, the available capacity decreases. Considering that the difference in capacity retention rate between Example 1 and Example 2 is slight, the range of x in Example 1 is practically superior to the range of x in Example 2.

### INDUSTRIAL APPLICABILITY

The invention can suppress a sharp capacity loss of secondary batteries in an early stage and extend the life of secondary batteries. Therefore, the invention is particularly useful when applied to devices in which capacity loss is evaluated more severely, such as electric vehicles.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

10 Charge/discharge system
12 Load Device
14 Power supply unit
16 Secondary Battery
18 Charge/Discharge Circuit
20 Voltage Detector

1. A system for controlling charge/discharge of a non-aqueous electrolyte secondary battery, comprising:
a non-aqueous electrolyte secondary battery having a positive electrode including a composite oxide containing lithium and nickel;
a charge/discharge circuit for discharging the secondary battery and charging the secondary battery with power from an external power source; and
a control unit for controlling the charge/discharge circuit such that the voltage of the secondary battery is within a voltage range having an end-of-discharge voltage Y as a lower limit value and an end-of-charge voltage X as an upper limit value,
wherein the control unit is configured to control the charge/discharge circuit such that:
(i) when a degree D of deterioration of the secondary battery is smaller than a reference value Dref, the secondary battery is charged and discharged in a voltage range A having a first end-of-charge voltage X1 as the end-of-charge voltage X and a first end-of-discharge voltage Y1 as the end-of-discharge voltage Y; and
(ii) when the degree D of deterioration is equal to or more than the reference value Dref, the secondary battery is charged and discharged in a voltage range B having a second end-of-charge voltage X2 and a second end-of-discharge voltage Y2 higher than the first end-of-discharge voltage Y1.

2. (canceled)

3. The system for controlling charge/discharge in accordance with claim 1, wherein the second end-of-charge voltage X2 is higher than the first end-of-charge voltage X1.

4. The system for controlling charge/discharge in accordance with claim 1,
wherein the composite oxide is represented by the chemical formula LiₓNi_{y}M_{1-y}O₂₊ₐ where M is a metal element other than Li and Ni, 0<x≦1.1, 0<y≦1, and 0≦a≦0.1, and
the voltage range A corresponds to x1≦x≦x2, and the voltage range B corresponds to x3≦x≦x4, where x3<x1 and x4<x2.

5. The system for controlling charge/discharge in accordance with claim 4, wherein 0.33≦x1≦0.37, 0.88≦x2≦0.92, 0.23≦x3≦0.27, and 0.73≦x4≦0.77.

6. The system for controlling charge/discharge in accordance with claim 1,
wherein the degree D of deterioration is the degree Dc of capacity decrease relative to an initial capacity Cint of the secondary battery,
the degree Dc of capacity decrease is represented by the formula (Cint−C)/Cint where C is the capacity of the secondary battery corresponding to the degree D of deterioration, and
the degree Dc of capacity decrease corresponding to the reference value Dref is 5 to 20%.

7. The system for controlling charge/discharge in accordance with claim 4, wherein M is at least one selected from the group consisting of Co, Mn, Al, Mg, Ti, Y, Zr, Nb, Mo, and W.

8. The system for controlling charge/discharge in accordance with claim 4, wherein M_{1-y} is Co_{z}L_{1-y-z}, L is at least one selected from the group consisting of Mn, Al, Mg, Ti, Y, Zr, Nb, Mo, and W, 0.5≦y≦0.9, and 0.05≦z≦0.2.

9. A battery pack comprising:
a non-aqueous electrolyte secondary battery having a positive electrode including a composite oxide containing lithium and nickel;
a charge/discharge circuit for discharging the secondary battery and charging the secondary battery with power from an external power source; and
a control unit for controlling the charge/discharge circuit for charging and discharging the secondary battery,
wherein the control unit is configured to control the charge/discharge circuit such that:
(i) when the degree D of deterioration of the secondary battery is smaller than a reference value Dref, the secondary battery is charged and discharged in a voltage range A having a first end-of-charge voltage X1 and a first end-of-discharge voltage Y1; and
(ii) when the degree D of deterioration is equal to or more than the reference value Dref, the secondary battery is charged and discharged in a voltage range B having a second end-of-charge voltage X2 and a second end-of-discharge voltage Y2 higher than the first end-of-discharge voltage Y1.

10. A method for controlling charge/discharge of a non-aqueous electrolyte secondary battery having a positive electrode including a composite oxide containing lithium and nickel, the method comprises:
(i) detecting the degree D of deterioration of the secondary battery;
(ii) charging and discharging the secondary battery in a voltage range A having a first end-of-charge voltage X1 and a first end-of-discharge voltage Y1 when the degree D of deterioration is smaller than a reference value Dref; and
(iii) charging and discharging the secondary battery in a voltage range B having a second end-of-charge voltage X2 and a second end-of-discharge voltage Y2 higher than the first end-of-discharge voltage Y1 when the degree D of deterioration is equal to or more than the reference value Dref.

11. The system for controlling charge/discharge in accordance with claim 1, including a voltage sensor for detecting the voltage of the secondary battery,
wherein the secondary battery has a rated capacity defined by a fully charged voltage Vfc and a fully discharged voltage Vfd, and
the control unit is configured to control the charge/discharge circuit based on an output of the voltage sensor such that:
(i) the secondary battery is charged and discharged in a voltage range E having an end-of-charge voltage Vct1 as the end-of-charge voltage X and an end-of-discharge voltage Vdt1 as the end-of-discharge voltage Y where Vct1≦Vfc and Vdt1>Vfd; and
(ii) the secondary battery is discharged to a voltage Vdt2 lower than the end-of-discharge voltage Vdt1 where Vdt2≧Vfd every time the number of charge/discharge cycles of the secondary battery as the variable related to deterioration of the secondary battery reaches a predetermined number of charge/discharge cycles.

12. The system for controlling charge/discharge in accordance with claim 11,
wherein the composite oxide is represented by the chemical formula LiₓNi_{y}M_{1-y}O₂₊ₐ where M is a metal element other than Li and Ni, 0<x≦1.1, 0<y≦1, and 0≦a≦0.1, and
the voltage range E corresponds to x5≦x≦x6 where 0.23≦x5≦0.27 and 0.73≦x6≦0.77.

13. The system for controlling charge/discharge in accordance with claim 11, wherein the predetermined number of charge/discharge cycles is in the range of 30 to 50.

14. The system for controlling charge/discharge in accordance with claim 12, wherein the voltage Vdt2 corresponds to 0.93≦x7≦0.97 where x7 represents x of the composite oxide.

15. The system for controlling charge/discharge in accordance with claim 11,
wherein while the secondary battery is discharged at a voltage higher than the end-of-discharge voltage Vdt1, the secondary battery is discharged at a discharge rate DRb of 0.5 to 2 C, and
while the secondary battery is discharged at a voltage equal to or less than the end-of-discharge voltage Vdt1, the secondary battery is discharged at a discharge rate DRs of 0.1 to 0.5 C where DRs<DRb.

16. The system for controlling charge/discharge in accordance with claim 11, further including a fully discharged state detector for detecting that the secondary battery is fully discharged,
wherein when the secondary battery is discharged to the voltage Vdt2, the secondary battery is further discharged until a fully discharged state is detected, to correct association between x of the composite oxide in the fully discharged state and the fully discharged voltage Vfd.

17. The system for controlling charge/discharge in accordance with claim 12, wherein M is at least one selected from the group consisting of Co, Mn, Al, Mg, Ti, Y, Zr, Nb, Mo, and W.

18. The system for controlling charge/discharge in accordance with claim 17, wherein M_{1-y} is Co_{z}L_{1-y-z}, L is at least one selected from the group consisting of Mn, Al, Mg, Ti, Y, Zr, Nb, Mo, and W, 0.5≦y≦0.9, and 0.05≦z≦0.2.

19. A battery pack comprising:
a non-aqueous electrolyte secondary battery having a positive electrode including a composite oxide containing lithium and nickel, the non-aqueous electrolyte secondary battery having a rated capacity defined by a fully charged voltage Vfc and a fully discharged voltage Vfd;
a charge/discharge circuit for discharging the secondary battery and charging the secondary battery with power from an external power source;
a control unit for controlling the charge/discharge circuit for charging and discharging the secondary battery; and
a voltage sensor for detecting the voltage of the secondary battery,
wherein the control unit is configured to control the charge/discharge circuit based on an output of the voltage sensor such that:
(i) the secondary battery is charged and discharged in a voltage range E having an end-of-charge voltage Vct1 and an end-of-discharge voltage Vdt1 where
Vct1≦Vfc and Vdt1>Vfd; and
(ii) the secondary battery is discharged to a voltage Vdt2 lower than the end-of-discharge voltage Vdt1 where Vdt2≧Vfd every time a predetermined number of charge/discharge cycles are performed.

20. A method for controlling charge/discharge of a non-aqueous electrolyte secondary battery having a positive electrode including a composite oxide containing lithium and nickel, the non-aqueous electrolyte secondary battery having a rated capacity defined by a fully charged voltage Vfc and a fully discharged voltage Vfd,
the method comprising:
(i) charging and discharging the secondary battery in a voltage range E having an end-of-charge voltage Vct1 and an end-of-discharge voltage Vdt1 where
Vct1≦Vct and Vdt1>Vfd; and
(ii) discharging the secondary battery to a voltage Vdt2 lower than the end-of-discharge voltage Vdt1 where Vdt2≧Vfd every time a predetermined number of charge/discharge cycles are performed.
